(19) United States
(12) Patent Application Publication
(10) Pub. No.: US 2016/0200917 A1
(43) Pub. Date: Jul. 14, 2016

(54) ANTI-CORROSION COATING

(71) Applicant: 3M INNOVATIVE PROPERTIES COMPANY, Saint Paul, MN (US)

(72) Inventors: Long Yin, Shanghai (CN); Xue-hua Chen, Shanghai (CN); Zhigang Yu, Shanghai (CN); Duyinzi Sun, Shanghai (CN); Wenbin Liu, Shanghai (CN); Naiyong Jing, Woodbury, MN (US)

(21) Appl. No.: 14/911,113

(22) PCT Filed: Aug. 15, 2014
(86) PCT No.: PCT/US14/51255

§ 371 Date: Feb. 9, 2016

(30) Foreign Application Priority Data
Aug. 22, 2013 (CN) 201310369756.9

(51) Int. Cl. C09D 5/08; B05D 3/00

(52) U.S. Cl. CPC C09D 5/086; B05D 3/007

(57) ABSTRACT

The present invention provides an anti-corrosion solution comprising reaction products of the following reaction components: 1-30 wt % of a tetraalkyl orthosilicate, with the total weight of said anti-corrosion solution being 100 wt %; 0.2-6.0 wt % of a metal salt, with the total weight of said anti-corrosion solution being 100 wt %, said metal salt comprising one or more selected from the group consisting of: an aluminum salt, a strontium salt, a chromium salt, a zirconium salt and a cerium salt; an acid; 3-90 wt % of water, with the total weight of said anti-corrosion solution being 100 wt %; 4-95 wt % of an alcohol, with the total weight of said anti-corrosion solution being 100 wt %; said anti-corrosion solution having a pH value less than or equal to 4. The anti-corrosion solution provided by the present invention can form a dense transparent anti-corrosion coating layer on a substrate surface, the anti-corrosion coating layer having a good corrosion resistance performance.

### CROSS-REFERENCE TO RELATED APPLICATIONS

This application claims priority to Chinese Patent Application No. CN201310369756.9, filed on Aug. 22, 2013, the disclosure of which is incorporated by reference in its entirety.

### TECHNICAL FIELD

The present invention relates to the field of anti-corrosion, in particular to an anti-corrosion solution.

### BACKGROUND OF THE INVENTION

Metal materials such as stainless steel, aluminum and aluminum alloy are widely used in the fields of transportation, aeronautics and astronautics, energy, electronics, architecture, upholstery, household electrical appliances, etc. Most metals are susceptible to corrosion when exposed to humid air and corrosive liquids. Such corrosion may severely affect the quality of the metals and the products made of the metals. In China, metal corrosion causes an economic loss of as high as tens of billion RMB per year.

In order to alleviate or prevent metal corrosion, the most commonly used method is to apply an anti-corrosion coating layer to the metal surface to avoid contact of a corrosive medium with the metal substrate. For example, the metal substrate can be chemically treated by using chromate salt or phosphate salt. However, from the point of view of health and environmental protection, neither chromate nor phosphate salts are a good option. In recent years, the technology of depositing an ultra-thin anti-corrosion coating layer onto a metal surface by sol-gel method is developing very quickly. Such a process achieves an anti-corrosion effect equivalent to that achievable with chromate salt and phosphate salts, and is health-friendly and environment-friendly, having a good prospect of application in the future.

KR100995938 discloses a ceramic coating material prepared from tetraethyl orthosilicate, zinc acetate, ethanol, water, hydrochloric acid, glycidol and sulphuric acid in certain proportions, in which glycidol and sulphuric acid are indispensable ingredients. Such ceramic coating material does not have a desirable anti-corrosion effect.

US2012204762 discloses an aqueous composition prepared from the reaction of aminoalkylalkoxysilane, alkoxysilane, metal salt, and water in the presence of a catalyst. The aqueous composition disclosed by this patent is resistant to salt spray for up to 211 hours but cannot meet higher requirements for corrosion resistance.

### SUMMARY OF THE INVENTION

It is an object of the present invention to provide a novel anti-corrosion solution to meet higher requirements for corrosion resistance.

According to one aspect of the present invention, the present invention provides an anti-corrosion solution comprising a reaction product of the following reaction components, wherein the reaction components comprise:

1-30 wt % of a tetraalkyl orthosilicate, with the total weight of the anti-corrosion solution being 100 wt %;

0.2-6.0 wt % of a metal salt, with the total weight of the anti-corrosion solution being 100 wt %, the metal salt comprising one or more selected from the group consisting of: an aluminum salt, a strontium salt, a chromium salt, a zirconium salt, and a cerium salt;

an acid;

3-90 wt % of water, with the total weight of the anti-corrosion solution being 100 wt %;

4-95 wt % of an alcohol, with the total weight of the anti-corrosion solution being 100 wt %;

and the anti-corrosion solution has a pH value less than or equal to 4.

According to some particular embodiments of the present invention, the tetraalkyl orthosilicate is represented by the general formula of Si(OR)₄, wherein R represents an alkyl group having 1 to 4 carbons, the alkyl group comprising one or more selected from the group consisting of: methyl, ethyl, n-propyl, isopropyl, and n-butyl.

According to some particular embodiments of the present invention, the content of tetraalkyl orthosilicate is from 5 to 10 wt %.

According to some particular embodiments of the present invention, the metal salt comprises one or more selected from the group consisting of: aluminum nitrate, strontium nitrate, chromium nitrate, zirconium nitrate, and cerium nitrate.

According to some particular embodiments of the present invention, the content of metal salt is from 0.5 to 4.0 wt %.

According to some particular embodiments of the present invention, the acid is an inorganic acid or an organic acid; the inorganic acid comprises one or more selected from the group consisting of hydrochloric acid, nitric acid, and phosphoric acid; and the organic acid comprises one or more selected from the group consisting of: formic acid, acetic acid, and citric acid.

According to some particular embodiments of the present invention, the content of water is from 3.58 to 89.23 wt %.

According to some particular embodiments of the present invention, the alcohol comprises one or more selected from the group consisting of: ethanol, n-propanol, isopropanol, and n-butanol.

According to some particular embodiments of the present invention, the content of alcohol is from 4.17 to 94.53 wt %.

According to some particular embodiments of the present invention, the anti-corrosion solution further comprises 0.05 to 2.0 wt % of nanosilica particles, with the total weight of the anti-corrosion solution being 100 wt %.

According to some particular embodiments of the present invention, the nanosilica particles have an average particle diameter of 2 to 20 nm.

According to some particular embodiments of the present invention, the anti-corrosion solution further comprises an organic silane.

According to some particular embodiments of the present invention, the organic silane is a perfluoropolyether silane, and the content of perfluoropolyether silane is from 0.08 to 5.0 wt %, with the total weight of the anti-corrosion solution being 100 wt %.

According to some particular embodiments of the present invention, the organic silane is a quaternary ammonium salt zwitterionic silane, and the content of quaternary ammonium salt zwitterionic silane is from 0.5 to 3.1 wt %, with the total weight of the anti-corrosion solution being 100 wt %.

According to some particular embodiments of the present invention, the anti-corrosion solution further comprises 0.05 to 2.0 wt % of a surfactant, with the total weight of the anti-corrosion solution being 100 wt %.

According to some particular embodiments of the present invention, the surfactant comprises one or more selected from the group consisting of: a nonionic surfactant, an anionic surfactant, and an amphoteric surfactant.

According to some particular embodiments of the present invention, the nonionic surfactant comprises one or more selected from the group consisting of: a polyoxyethylene-type nonionic surfactant, a polyol-type nonionic surfactant, an alkanolamide-type nonionic surfactant, a fluorocarbon-type nonionic surfactant, a silicone-type nonionic surfactant, and a modified silicone-type nonionic surfactant.

According to some particular embodiments of the present invention, the anionic surfactant comprises one or more selected from the group consisting of: a carboxylate-type anionic surfactant, a sulphonate-type anionic surfactant, a sulphate-type anionic surfactant, and a phosphate-type anionic surfactant.

According to some particular embodiments of the present invention, the amphoteric surfactant comprises one or more selected from the group consisting of: an amino acid-type amphoteric surfactant, a betaine-type amphoteric surfactant, and an imidazoline-type amphoteric surfactant.

In another aspect, the present invention provides an anti-corrosion article comprising a substrate and an anti-corrosion coating layer positioned adjacent to the substrate. The anti-corrosion coating layer comprises a layer of the anti-corrosion solution provided by the present invention that has been dried to remove the solvent.

According to some particular embodiments of the present invention, the substrate comprises one or more selected from the group consisting of: a stainless steel substrate, a glass substrate, an aluminum substrate, an aluminum alloy substrate, a ceramic substrate, and a painted substrate.

In another aspect, the present invention provides a method for making an anti-corrosion article. The method comprises the steps of applying the anti-corrosion solution provided by the present invention to a substrate to form a layer of the anti-corrosion solution positioned adjacent to the substrate and then drying the layer of the anti-corrosion solution to remove the solvent and form an anti-corrosion coating layer.

According to some particular embodiments of the present invention, the method comprises one or more selected from the group consisting of: dip coating application, spray coating application, roll coating application and brush coating application.

According to some particular embodiments of the present invention, the substrate comprises one or more selected from the group consisting of: a stainless steel substrate, a glass substrate, an aluminum substrate, an aluminum alloy substrate, a ceramic substrate, and a painted substrate (e.g., a painted plate).

The anti-corrosion coating layer and anti-corrosion article formed with the anti-corrosion solution provided by the present invention have good corrosion resistance, and do not affect the appearance of the substrate surface.

The above summary of the present invention is not intended to describe each and every disclosed example of every embodiment of the present invention. The description that follows more particularly exemplifies illustrative examples so that the characteristics and advantages of both the above-described and the further embodiments of the present invention become more obvious.

### DETAILED DESCRIPTION OF THE INVENTION

It is to be understood that various other embodiments of the present invention can be contemplated and modifications thereto can be made by those skilled in the art according to the teaching of the present disclosure without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range and any range within that range. For example, 1, 2, 3, 4 and 5 include 1, 1.1, 1.3, 1.5, 2, 2.75, 3, 3.80, 4 and 5 etc.

### Anti-Corrosion Solution

The anti-corrosion solution provided by the present invention can form a dense transparent anti-corrosion coating layer on a substrate surface, the anti-corrosion coating layer having good corrosion resistance without affecting the appearance of the substrate surface. The anti-corrosion solution comprises a reaction product of the following reaction components: 1 to 30 wt % of a tetraalkyl orthosilicate, with the total weight of the anti-corrosion solution being 100 wt %; 0.2 to 6.0 wt % of a metal salt, with the total weight of the anti-corrosion solution being 100 wt %, the metal salt comprising one or more selected from the group consisting of: an aluminum salt, a strontium salt, a chromium salt, a zirconium salt, and a cerium salt; an acid; 3 to 90 wt % of water, with the total weight of the anti-corrosion solution being 100 wt %; and 4 to 95 wt % of an alcohol, with the total weight of the anti-corrosion solution being 100 wt %; the anti-corrosion solution having a pH value less than or equal to 4.

The tetraalkyl orthosilicate is represented by the general formula of Si(OR)₄, wherein R represents an alkyl group having 1 to 4 carbons. The alkyl group can preferably be one or more of the following: methyl, ethyl, n-propyl, isopropyl, and n-butyl. The tetraalkyl orthosilicate can preferably be one or more of the following: tetramethyl orthosilicate, tetraethyl orthosilicate, tetra-n-propyl orthosilicate, tetraisopropyl orthosilicate, and tetra-n-butyl orthosilicate. The content of tetraalkyl orthosilicate is from 1 to 30 wt %, preferably from 3 to 20 wt %, and more preferably from 5 to 10 wt %, with the total weight of the anti-corrosion solution being 100 wt %. Stated differently, the amount of tetralkyl orthosilicate is 1 to 30 wt % based on the total weight of the anti-corrosion solution. If the content of tetraalkyl orthosilicate is less than 1 wt %, it will probably not be easy to form an anti-corrosion coating layer of a desired thickness on a substrate, such that the corrosion resistance of the anti-corrosion coating layer or the anti-corrosion article provided by the present invention is inferior, and the objective of the invention is not achieved. If the content of tetraalkyl orthosilicate is greater than 30 wt %, then the appearance of the resulting anti-corrosion coating layer will look hazy, resulting in the anti-corrosion article prepared having a noticeably inferior appearance.

The metal salt can be a divalent metal salt, a trivalent metal salt, a tetravalent metal salt, or a mixture thereof. The divalent metal salt can be a nitrate, preferably strontium nitrate. The trivalent metal salt can be a nitrate, preferably aluminum nitrate, cerium nitrate, and chromium nitrate. The tetravalent metal salt can be a nitrate, preferably zirconium nitrate. The metal salt mixture can be a mixture of any one or more of the divalent metal salt, the trivalent metal salt, and the tetravalent metal salt, preferably a mixture of aluminum nitrate and cerium nitrate. The content of metal salt is from 0.2 to 6.0 wt %, preferably from 0.4 to 4.0 wt %, and more preferably from 0.5 to 4.0 wt %, with the total weight of the anti-corrosion solution being 100 wt %. Stated differently, the amount of metal salt is 0.2 to 6 wt % based on the total weight of the anti-corrosion solution. If the content of metal salt is less than 0.2 wt %, the anti-corrosion coating layer and the anti-corrosion article prepared using such anti-corrosion solution will probably have inferior corrosion resistance. If the content of metal salt is greater than 6.0 wt %, then there will be the problem of the metal salt not being completely dissolved or the concentration of the metal salt being too high.

The acid is an inorganic acid or an organic acid. The inorganic acid is preferably one or more of the following: phosphoric acid, hydrochloric acid, and nitric acid, more preferably phosphoric acid and hydrochloric acid. The organic acid can be preferably one or more of the following: formic acid, acetic acid, and citric acid, more preferably formic acid and acetic acid. There is no particular limitation on the amount of the acid, so long as it is such that the pH value of the anti-corrosion solution is less than or equal to 4, preferably 1 to 3, more preferably 1 to 2. When the pH value of the anti-corrosion solution is greater than 4, both the anti-corrosion coating layer and the anti-corrosion article prepared using such anti-corrosion solution will probably have inferior corrosion resistance, such that the desired corrosion resistance of the anti-corrosion coating layer or the anti-corrosion article provided by the present invention is not achieved.

The content of water is from 3.58 to 89.23 wt %, with the total weight of the anti-corrosion solution being 100 wt %. Stated differently, the amount of water is 3.58 to 89.23 wt % based on the total weight of the anti-corrosion solution.

The alcohol can be preferably one or more of the following: ethanol, isopropanol, n-propanol, and n-butanol. The content of alcohol is from 4.17 to 94.53 wt %, with the total weight of the anti-corrosion solution being 100 wt %. Stated differently, the amount of alcohol is 4.17 to 94.53 wt % based on the total weight of the anti-corrosion solution.

If the content of water is less than 3 wt % or the content of alcohol is greater than 95 wt %, then the tetraalkyl orthosilicate among the reaction components will probably not be completely hydrolyzed. When such tetraalkyl orthosilicate reacts with other reaction components forming an anti-corrosion solution, both the anti-corrosion coating layer and the anti-corrosion article prepared using such anti-corrosion solution will probably have inferior corrosion resistance, such that the desired corrosion resistance of the anti-corrosion coating layer or the anti-corrosion article provided by the present invention is not achieved. If the content of water is greater than 90 wt % or the content of alcohol is less than 4 wt %, then the hydrolysis rate of the tetraalkyl orthosilicate among the reaction components will probably be decreased. When such tetraalkyl orthosilicate reacts with other reaction components forming an anti-corrosion solution, both the anti-corrosion coating layer and the anti-corrosion article prepared using such anti-corrosion solution will probably have inferior corrosion resistance performance, such that the desired corrosion resistance of the anti-corrosion coating layer or the anti-corrosion article provided by the present invention is not achieved.

The anti-corrosion solution of the present invention may further comprise nanosilica particles or organic silane. A coating layer can be formed using the anti-corrosion solution comprising the nanosilica particles or organic silane, the coating surface being easy to clean. The nanosilica particles have an average particle diameter of 2 to 20 nm, preferably 2 to 5 nm, and more preferably 5 nm. The anti-corrosion solution may comprise the nanosilica particles having a single average particle size, or may comprise the nanosilica particles having two or more average particle sizes. The content of nanosilica particles is from 0.05 to 2.0 wt %, with the total weight of the anti-corrosion solution being 100 wt %. Stated differently, the amount of nanosilica particles is in a range of 0.05 to 2.0 wt % based on the total weight of the anti-corrosion solution. The organic silane is preferably perfluoropolyether silane or quaternary ammonium salt zwitterionic silane. The content of perfluoropolyether silane is preferably from 0.08 to 5.0 wt %, more preferably from 0.1 to 0.5 wt %, and most preferably from 0.2 to 0.45 wt %, with the total weight of the anti-corrosion solution being 100 wt %. The content of quaternary ammonium salt zwitterionic silane is from 0.5 to 3.1 wt %, more preferably from 0.5 to 2.0 wt %, and most preferably from 0.5 to 1.0 wt %, with the total weight of the anti-corrosion solution being 100 wt %.

The anti-corrosion solution of the present invention may further comprise a surfactant. A coating layer may be formed using the anti-corrosion solution comprising the surfactant, the surface of the coating layer having good wettability. The surfactant may preferably be one or more of the following: a nonionic surfactant, an anionic surfactant, and an amphoteric surfactant. The nonionic surfactant may preferably be one or more of the following: a polyoxyethylene-type nonionic surfactant, a polyol-type nonionic surfactant, an alkanolamide-type nonionic surfactant, a fluorocarbon-type nonionic surfactant, a silicone-type nonionic surfactant, and a modified silicone-type nonionic surfactant. The anionic surfactant may preferably be one or more of the following: a carboxylate-type anionic surfactant, a sulphonate-type anionic surfactant, a sulphate-type anionic surfactant and a phosphate-type anionic surfactant. The amphoteric surfactant may preferably be one or more of the following: an amino acid-type amphoteric surfactant, a betaine-type amphoteric surfactant, and an imidazoline-type amphoteric surfactant. The content of surfactant is preferably from 0.05 to 2.0 wt %, more preferably from 0.05 to 1.0 wt %, and most preferably from 0.2 to 0.5 wt %, with the total weight of the anti-corrosion solution being 100 wt %. Stated differently, the surfactant can be present in an amount in a range of 0.05 to 2.0 wt % based on the total weight of the anti-corrosion solution.

### Anti-Corrosion Article and Method of Making

In another aspect, the present invention provides an anti-corrosion article comprising a substrate and an anti-corrosion coating layer positioned adjacent to the substrate. The anti-corrosion coating layer is a layer of the anti-corrosion solution provided by the present invention that has been dried to remove the solvent. Refer to the “Anti-corrosion solution” section of the present disclosure for the description of the anti-corrosion solution. The anti-corrosion coating layer has good corrosion resistance. Additionally, as the anti-corrosion coating layer is transparent, the appearance of a substrate surface on which the coating layer is applied will not be affected.

The method of preparing an anti-corrosion article comprises the step of applying the anti-corrosion solution provided by the present invention to a substrate to position a layer of the anti-corrosion solution adjacent to the substrate. The anti-corrosion solution can be applied using the application methods known in the prior art. The application methods may preferably be one or more of the following: dip coating application, spray coating application, roll coating application, and brush coating application. Then, the layer of anti-corrosion solution is dried to form the anti-corrosion coating layer. The anti-corrosion coating layer can have any desired thickness such as in a range of 100 to 1000 nm, in a range of 200 to 800 nm, or in a range of 300 to 600 nm. Any suitable drying method can be used. The coated substrate often dried by heating at an elevated temperature (a temperature above room temperature) such as at a temperature in a range of 40° C. to 200° C., in a range of 80° C. to 180° C., or in a range of 120° C. to 180° C. Any suitable substrate can be used. The substrate can be metal, a metal alloy, a polymeric material, a glass or ceramic composition, or a combination thereof. The substrate may preferably be one or more of the following: a stainless steel substrate, a glass substrate, an aluminum substrate, an aluminum alloy substrate, a ceramic substrate, and a painted substrate such as a painted plate. The painted substrate may preferably be a substrate coated with polyester, polyurethane or epoxy resin; and the substrate is preferably a metal substrate or a wood substrate.

The anti-corrosion article has good corrosion resistance.

Various embodiments are provided that include anti-corrosion solutions, anti-corrosion articles, and methods of making anti-corrosion articles.

Embodiment 1 is an anti-corrosion solution that comprises a reaction product of the following reaction components: (a) from 1 to 30 wt % of a tetraalkyl orthosilicate, with the total weight of the anti-corrosion solution being 100 wt %; (b) from 0.2 to 6.0 wt % of a metal salt, with the total weight of the anti-corrosion solution being 100 wt %, the metal salt comprising one or more selected from the group consisting of an aluminum salt, a strontium salt, a chromium salt, a zirconium salt, and a cerium salt; (c) an acid; (d) from 3 to 90 wt % of water, with the total weight of the anti-corrosion solution being 100 wt %; and (e) from 4 to 95 wt % of an alcohol, with the total weight of the anti-corrosion solution being 100 wt %. The anti-corrosion solution has a pH value less than or equal to 4.

Embodiment 2 is the anti-corrosion solution according to embodiment 1, wherein: the tetraalkyl orthosilicate is represented by the general formula Si(OR)₄, wherein R represents an alkyl group having from 1 to 4 carbons, the alkyl group comprising one or more selected from the group consisting of methyl, ethyl, n-propyl, isopropyl, and n-butyl groups.

Embodiment 3 is the anti-corrosion solution according to embodiment 1 or 2, wherein a content of the tetraalkyl orthosilicate is from 5 to 10 wt %.

Embodiment 4 is the anti-corrosion solution according to any one of embodiments 1 to 3, wherein the metal salt comprises one or more selected from the group consisting of aluminum nitrate, strontium nitrate, chromium nitrate, zirconium nitrate and cerium nitrate.

Embodiment 5 is the anti-corrosion solution according to any one of embodiments 1 to 4, wherein a content of the metal salt is from 0.5 to 4.0 wt %.

Embodiment 6 is the anti-corrosion solution according to any one of embodiments 1 to 5, wherein:
the acid is an inorganic acid or an organic acid;
the inorganic acid comprising one or more selected from the group consisting of hydrochloric acid, nitric acid, and phosphoric acid; and
the organic acid comprising one or more selected from the group consisting of formic acid, acetic acid, and citric acid.

Embodiment 7 is the anti-corrosion solution according to any one of embodiments 1 to 6, wherein the alcohol comprises one or more selected from the group consisting of ethanol, n-propanol, isopropanol, and n-butanol.

Embodiment 8 is the anti-corrosion solution according to any one of embodiments 1 to 7, wherein a content of water is from 3.58 to 89.23 wt %, and a content of the alcohol is from 4.17 to 94.53.

Embodiment 9 is the anti-corrosion solution according to any one of embodiments 1 to 8, wherein the anti-corrosion solution further comprises from 0.05 to 2.0 wt % of nanosilica particles, with the total weight of the anti-corrosion solution being 100 wt %.

Embodiment 10 is the anti-corrosion solution according to embodiment 9, wherein the nanosilica particles have an average particle diameter of 2 to 20 nm.

Embodiment 11 is the anti-corrosion solution according to any one of embodiments 1 to 10, wherein the anti-corrosion solution further comprises an organic silane.

Embodiment 12 is the anti-corrosion solution according to embodiment 11, wherein: the organic silane is perfluoropolyether silane, a content of the perfluoropolyether silane being from 0.08 to 5.0 wt %, with the total weight of the anti-corrosion solution being 100 wt %.

Embodiment 13 is the anti-corrosion solution according to embodiment 11, wherein: the organic silane is a quaternary ammonium salt zwitterionic silane, the quaternary ammonium salt zwitterionic silane being in an amount of 0.5-3.1 wt %, with the total weight of the anti-corrosion solution being 100 wt %.

Embodiment 14 is the anti-corrosion solution according to any one of embodiments 1 to 13, wherein the anti-corrosion solution further comprises from 0.05 to 2.0 wt % of a surfactant, with the total weight of the anti-corrosion solution being 100 wt %.

Embodiment 15 is the anti-corrosion solution according to embodiment 14, wherein the surfactant comprises one or more selected from the group consisting of a nonionic surfactant, an anionic surfactant, and an amphoteric surfactant.

Embodiment 16 is the anti-corrosion solution according to embodiment 15, wherein the nonionic surfactant comprises one or more selected from the group consisting of a polyoxyethylene-type nonionic surfactant, a polyol-type nonionic surfactant, an alkanolamide-type nonionic surfactant, a fluorocarbon-type nonionic surfactant, a silicone-type nonionic surfactant, and a modified silicone-type nonionic surfactant.

Embodiment 17 is the anti-corrosion solution according to embodiment 15, wherein the anionic surfactant comprises one or more selected from the group consisting of a carboxylate-type anionic surfactant, a sulphonate-type anionic surfactant, a sulphate-type anionic surfactant, and a phosphate-type anionic surfactant.

Embodiment 18 is the anti-corrosion solution according to embodiment 15, wherein the amphoteric surfactant comprises one or more selected from the group consisting of an amino acid-type amphoteric surfactant, a betaine-type amphoteric surfactant, and an imidazoline-type amphoteric surfactant.

Embodiment 19 is an anti-corrosion article comprising a substrate and an anti-corrosion coating layer positioned adjacent to the substrate, wherein the anti-corrosion layer comprises a layer of the anti-corrosion solution according to any one of embodiments 1 to 18 that has been dried to remove the solvent.

Embodiment 20 is the anti-corrosion article according to embodiment 19, wherein the substrate comprises one or more selected from the group consisting of a stainless steel substrate, a glass substrate, an aluminum substrate, an aluminum alloy substrate, a ceramic substrate, and a painted substrate.

Embodiment 21 is a method of forming an anti-corrosion article, the method comprising:
applying the anti-corrosion solution described in any one of embodiments 1 to 18 to a substrate to form a layer of the anti-corrosion solution positioned adjacent to the substrate; and
drying the layer of the anti-corrosion solution to remove the solvent and form an anti-corrosion coating layer.

Embodiment 22 is the method according to embodiment 21, wherein applying comprises one or more selected from the group consisting of dip coating application, spray coating application, roll coating application, and brush coating application.

Embodiment 23 is the method according to embodiment 21 or 22, wherein the substrate comprises one or more selected from the group consisting of a stainless steel substrate, a glass substrate, an aluminum substrate, an aluminum alloy substrate, a ceramic substrate, and a painted substrate.

### EXAMPLES

The examples and comparative examples provided below will facilitate the comprehension of the present invention. These examples and comparative examples shall not be construed as limiting the scope of the prevent invention. All parts and percentages are based on weight, unless stated otherwise.

The raw materials utilized in the examples and comparative examples of the present invention are shown in Table 1.

TABLE 1
Raw materials utilized in examples and comparative examples

| Product name | Chemical properties/Specifications | Suppliers |
|---|---|---|
| Tetraethyl orthosilicate | TEOS, Purity >98.5 wt % | Sinopharm (Shanghai) |
| Tetramethyl | TMOS, Purity >98.5 wt % | Onichem |
| orthosilicate | | |
| Ethyl acetate | Purity >99.5 wt % | Jiangsu QiangSheng |
| Isopropanol | IPA, Purity >99.7 wt % | Chemical Co., Ltd. |
| Ethanol | Purity >99.7 wt % | |
| n-Butanol | Purity >99.0 wt % | Shanghai Wulian Chemical |
| | | Plant |
| n-Propanol | Purity >99.0 wt % | Shanghai Lingfeng |
| | | Chemical Reagent Co., Ltd. |
| Hydrochloric acid | HCl, Purity = 36~38 wt % | Sinopharm (Shanghai) |
| Phosphoric acid | H₃PO₄, Purity >85.0 wt % | |
| Nitric acid | HNO₃, Purity = 65~68 wt % | |
| Acetic acid | CH₃COOH, Purity >99.5 wt % | |
| Formic acid | HCOOH, Purity >88.0 wt % | Shanghai Aibi Chemistry |
| Citric acid | C₆H₈O₇•H₂O, Purity >99.5 wt % | Preparation Co., Ltd. |
| Strontium nitrate | Sr(NO₃)₂, Purity >99.0 wt % | |
| Aluminum nitrate | Al(NO₃)₃, Purity >99.0 wt % | |
| Chromic nitrate | Cr(NO₃)₃, Purity >99.0 wt % | Shanghai Zhanyun |
| Zirconium nitrate | Zr(NO₃)₄, Purity >99.0 wt % | Chemical Co., Ltd. |
| Cerium nitrate | Ce(NO₃)₃, Purity >99.0 wt % | |
| Nanosilica aqueous | Nalco 8699, Solid content 16 wt %, | Nalco |
| dispersion | Average particle diameter = 2 nm, pH = 9 | |
| | Nalco 2326, Solid content 16 wt %, | |
| | Average particle diameter = 5 nm, pH = 9 | |
| | Nalco 1050, Solid content 50 wt %, | |
| | Average particle diameter = 20 nm, pH = 9 | |
| Perfluoropolyether | ECC-1000, Purity >99.5 wt % | 3M |
| silane | HFPO-QUAT silane, 50 wt % Isopropanol | |
| | solution | |
| Quaternary ammonium | Zwitterionic silane, 50 wt % aqueous | |
| salt zwitterionic silane | solution | |
| Nonionic surfactant | D-Glucopyranose, oligomeric, decyl octyl | Dow Chemicals |
| | glycoside, TRITON BG-10, 70 wt % | |
| | aqueous solution | |
| | Secondary alcohol polyoxyethylene ether, | Shanghai Demao Chemical |
| | S-90 | Co., Ltd. |
| Anionic surfactant | Sodium dodecyl sulfate (SDS), | Sinopharm (Shanghai) |
| | Purity >97.0 wt % | |
| Amphoteric surfactant | Disodium cocoampho dipropionate, | Rhodia Co. |
| | MIRANOL C2M | |
| 304 Stainless steel | 5 cm × 10 cm × 1 mm | Suzhou Hengqiang Stainless |
| panel | | Steel Material Co, Ltd. |
| 443 Stainless steel | 5 cm × 10 cm × 1 mm | |
| panel | | |
| 439 Stainless steel | 5 cm × 10 cm × 1 mm | |
| panel | | |
| 430 Stainless steel | 5 cm × 10 cm × 1 mm | |
| panel | | |
| Aluminum plate | 5 cm × 10 cm × 1 mm | Southwest Aluminum Co. |
| Glass | 18 cm × 10 cm × 3 mm | Shanghai Jinqia Trade Co., |
| | | Ltd. |
| Ceramic | 15 cm × 10 cm × 10 mm | Shanghai Bohao Building |
| | | Material Co., Ltd. |
| Painted plate | 15 cm × 7 cm × 1 mm | Shanghai Chunhui Industry |
| | | Co., Ltd. |
| Ketchup | KNORR | Unilever (China) Ltd. |
| Chilli sauce | ZHANG SHI JI | Shanghai Hongning Foods |
| | | Co., Ltd. |
| Soy sauce | LEE KUM KEE (Mushroom Dark Soy | LKK (Xinhui) Foods Co., |
| | Sauce) | Ltd. |

The present invention evaluated the corrosion-resistance performance of the anti-corrosion coating layer or anti-corrosion article provided in the examples and the comparative examples mainly through the salt spray resistance performance test. Based on this, the present invention further evaluated the other performance of the anti-corrosion coating layer or anti-corrosion article provided in the examples and the comparative examples through the food stain resistance performance test, durability performance test, acid resistance performance test, high temperature and high humidity resistance performance test, and the surface wettability performance test.

### Salt Spray Resistance Performance Test

The anti-corrosion solution is coated on the substrate to form an anti-corrosion coating layer on the substrate surface, producing an anti-corrosion article.

The instrument used to test the salt spray resistance performance is Q-Fog SF-1 600L, available from Q-Lab.

An “X” is inscribed with a blade on the surface of the anti-corrosion article, and the article then placed in the salt spray box (Q-Fog SF-1 600L) for the salt spray test.

The salt spray test is conducted in accordance with ASTM B117. The anti-corrosion article is taken out every 10 hrs, washed with clean water, blow-dried with compressed air, and visibly observed to see if there is any rust corrosion exceeding 2 mm along the edge of the “X” notch, or if there is any rust stain on the anti-corrosion coating layer, or if there is any peeling off of the anti-corrosion coating layer. If any of these occurs, the test is stopped, and the total test time is recorded. If none of these occurs, the salt spray test is continued until the total test time reaches 1000 hrs, then the total test time is recorded as 1000 hrs. If no peeling occurs when taken out at 30 hrs, but peeling occurred when taken out at 40 hrs, then the salt spray resistance time is recorded as 40 hrs.

If the measured salt spray resistance performance of an anti-corrosion article is equal to or greater than 250 hrs, it proves that the anti-corrosion article has good salt spray resistance performance

The test results of the salt spray resistance performance of the anti-corrosion article provided in the examples and comparative examples of the present invention are listed in Table 4.

### Food Stain Resistance Performance Test

The anti-corrosion solution is coated on the substrate to form an anti-corrosion coating layer on the substrate surface, producing an anti-corrosion article.

One drop of soy sauce, one drop of ketchup and one drop of chilli sauce are respectively dropped onto the anti-corrosion coating layer, and the surface of the anti-corrosion coating layer is covered with a glass plate, placed at room temperature for 18 hrs, first washed with clean water, then blow-dried with compressed air, and visibly observed to see if there is any peeling off of the anti-corrosion coating layer. If peeling occurs, then it is marked as “fail”; if no peeling occurs, then it is marked as “pass”.

If the measured anti-corrosion article passes two or more than two food stain resistance performance tests mentioned above, it proves that the anti-corrosion article has good food stain resistance performance.

The test results of the food stain resistance performance of the anti-corrosion article provided in the examples and comparative examples of the present invention are listed in Table 5.

### Durability Performance Test

The durability performance of the anti-corrosion coating layer is characterized by a wet abrasion test.

The instrument used to test the durability is Sheen Wet Abrasion Scrub Tester REF 903, available from Sheen.

The anti-corrosion solution is coated on the substrate to form an anti-corrosion coating layer on the substrate surface, producing an anti-corrosion article. Under a 1 kg load, the surface of the anti-corrosion coating layer was abraded with an abrasive material, the abrasive material being the Miuge brand sponge universal cleaning pad exclusively for anti-stick pots, available from Huangzhou Miuge Chemical Commodities Science & Technology Co., the friction medium being water. Under visual observation, the test is stopped when the anti-corrosion coating layer peels off under friction, and the number of friction cycles of the test (one friction cycle is one back and forth of the abrasive material) is recorded. Under visual observation, if the anti-corrosion coating layer shows no peeling when the number of friction cycles reaches 20000, the test is stopped, and the number of friction cycles is recorded as 20000.

If the number of friction cycles of the measured anti-corrosion article reaches 20000, it proves that the anti-corrosion article has good durability.

The test results of the durability performance of the anti-corrosion article provided in the examples and comparative examples of the present invention are listed in Table 6.

### Acid Resistance Performance Test

The anti-corrosion solution is coated on the substrate to form an anti-corrosion coating layer on the substrate surface, producing an anti-corrosion article.

The anti-corrosion article is immersed into the aqueous solution of 10 wt % acetic acid, placed at room temperature for 5 hrs, after being taken out, it is washed with clean water, blow-dried with compressed air, and visibly observed to see if there is any peeling off of the anti-corrosion coating layer. If peeling off occurs, it is marked as “fail”; if no peeling off occurs, it is marked as “pass”.

If the measured anti-corrosion article passes the acid resistance performance test, it proves that the anti-corrosion article has good acid resistance performance.

The test results of the acid resistance performance of the anti-corrosion article provided in the examples and comparative examples of the present invention are listed in Table 6.

### High Temperature and High Humidity Resistance Performance Test

The anti-corrosion solution is coated on the substrate to form an anti-corrosion coating layer on the substrate surface, producing an anti-corrosion article.

The instrument used to test high temperature and high humidity resistance performance is the X-Rite 8400 colorimeter, available from X-Rite.

The anti-corrosion article is immersed into boiling water for 2 hrs, after being taken out, it is first washed with clean water, then blow-dried with compressed air.

The X-Rite 8400 colorimeter is used to measure the delta E value of the anti-corrosion coating layer before and after the test. The smaller the delta E value, the smaller the color difference change of the anti-corrosion coating layer before and after the test, the better the high temperature and high humidity resistance performance. If the delta E value is greater than or equal to 1, it is marked as “fail”; if the delta E value is smaller than 1, it is marked as “pass”.

If the measured anti-corrosion article passes the high temperature and high humidity resistance performance test, it proves that the anti-corrosion article has good high temperature and high humidity resistance performance.

The test results of the high temperature and high humidity resistance performance of the anti-corrosion article provided in the examples and comparative examples of the present invention are listed in Table 6.

### Surface Wettability Performance Test

The surface wettability performance of the anti-corrosion coating layer is characterized by the contact angle.

The instrument used to test the surface wettability performance is the Kruss DSA100 automatic contact angle tester, available from Kruss.

The anti-corrosion solution is coated on the substrate to form an anti-corrosion coating layer on the substrate surface, producing an anti-corrosion article. A water drop of 5 μl is dropped on the surface of the anti-corrosion article, and the contact angle is measured once the shape of the water drop remains stable. The above test is repeated on three areas randomly selected from the surface of the anti-corrosion article, obtaining the numerical value of the three contact angles. The average value of the numerical values of the three contact angles is obtained.

If the average value of the water drop contact angle is smaller than 90 degrees, it proves that the surface of the anti-corrosion article has good hydrophilic effect; the smaller the value, the better the hydrophilicity; if the average value of the water drop contact angle is greater than 90 degrees, it proves that the surface of the anti-corrosion article has hydrophobic effect, and the larger the value, the better the hydrophobicity.

The test results of the surface wettability performance of the anti-corrosion article provided in the examples and comparative examples of the present invention are listed in Table 6.

### Preparation of Anti-Corrosion Solution

### Example 1

10.20 g of tetraethyl orthosilicate was added into a 500 ml glass bottle;

92.60 g of DI water and 92.60 g of isopropanol were added during the stirring process on a magnetic stirrer;

3.00 g of phosphoric acid (>85 wt %) was dropwise added to adjust the pH to 1 to 2;

After continuous stirring for 10 min, 20.40 g of 10 wt % aluminium nitrate aqueous solution was added;

After continuous stirring for 10 min, 4.38 g of 10 wt % TRITON BG-10 surfactant was added; After continuous stirring for 168 hrs at room temperature, a clear anti-corrosion solution was obtained, wherein the 168 hrs was recorded as the reaction time.

### Examples 2-25

The same procedure as in Ex. 1 is followed to prepare the anti-corrosion solutions of Ex. 2 to 25. The type, content and reaction time of the components included in the anti-corrosion solution are listed in Table 2.

### Example 26

10.20 g of tetraethyl orthosilicate was added into a 500 ml glass bottle;

92.60 g of DI water and 92.60 g of isopropanol were added during the stirring process on the magnetic stirrer;

After stirring for 10 min, 0.24 g of Nalco1050 (solid content: 50 wt % nanosilica aqueous dispersion, average particle diameter: 20 nm, pH=9) was added;

3.00 g of phosphoric acid (>85 wt %) was dropwise added to adjust the pH to 1 to 2;

After continuous stirring for 10 min, 20.40 g of 10 wt % aluminium nitrate aqueous solution was added;

After continuous stirring for 10 min, 4.20 g of disodium cocoampho dipropionate surfactant was added;

After continuous stirring for 168 hrs at room temperature, a clear anti-corrosion solution was obtained, wherein the 168 hrs was recorded as the reaction time.

### Examples 27-29

The same procedure as in Ex. 26 was followed to prepare the anti-corrosion solutions of Ex. 27 to 29. The type, content and reaction time of the components comprised in the anti-corrosion solution are listed in Table 2.

### Example 30

10.20 g of tetraethyl orthosilicate and 2.10 g of quaternary ammonium salt zwitterionic silane (50 wt % aqueous solution) were added into a 500 ml glass bottle;

66.01 g of DI water and 66.01 g of isopropanol were added during the stirring process on the magnetic stirrer;

2.04 g of phosphoric acid (>85 wt %) was dropwise added to adjust the pH to 1 to 2;

After continuous stirring for 10 min, 61.20 g of 5wt % aluminium nitrate aqueous solution was added;

After continuous stirring for 10 min, 4.08 g of 10 wt % TRITON BG-10 surfactant was added;

After continuous stirring for 168 hrs at room temperature, a clear anti-corrosion solution was obtained, wherein the 168 hrs was recorded as the reaction time.

### Examples 31-33

The same procedure as in Ex. 30 was followed to prepare the anti-corrosion solutions of Ex. 31 to 33. The type, content and reaction time of the components comprised in the anti-corrosion solution are listed in Table 2.

### Example 34

10.20 g of tetraethyl orthosilicate and 0.19 g of perfluoropolyether silane (ECC-1000) were added into a 500 ml glass bottle;

7.60 g of DI water and 177.60 g of isopropanol were added during the stirring process on the magnetic stirrer;

1.00 g of hydrochloric acid was dropwise added to adjust the pH to 1 to 2;

After continuous stirring for 10 min, 40.80 g of 10 wt % aluminium nitrate aqueous solution was added;

After continuous stirring for 24 hrs at room temperature, a slightly hazy anti-corrosion solution was obtained, wherein the 24 hrs was recorded as the reaction time.

### Examples 35-38

The same procedure as in Ex. 34 was followed to prepare the anti-corrosion solutions of Ex. 35 to 38. The type, content and reaction time of the components comprised in the anti-corrosion solution are listed in Table 2.

### Example 39

10.20 g of tetraethyl orthosilicate and 2.00 g of perfluoropolyether silane (HFPO-QUAT silane, 50 wt % of isopropanol solution) were added into a 500 ml glass bottle;

7.60 g of DI water and 177.60 g of isopropanol were added during the stirring process on the magnetic stirrer;

1.00 g of hydrochloric acid was dropwise added to adjust the pH to 1 to 2;

After continuous stirring for 10min, 40.80 g of 10 wt % aluminium nitrate aqueous solution was added;

After continuous stirring for 72 hrs at room temperature, a slightly turbid anti-corrosion solution was obtained, wherein the 72 hrs was recorded as the reaction time.

### Comparative Examples 1-2

The same procedure as Ex. 1 was followed to prepare the anti-corrosion solutions of CEx. 1-2. The anti-corrosion solution does not comprise nanosilica particles, organic silane or metal salt. The type, content and reaction time of the components of the anti-corrosion solution are listed in Table 2.

TABLE 2
Formulation of anti-corrosion solution

| | | | Nanosilica particle/ | | | | | |
|---|---|---|---|---|---|---|---|---|
| | Tetraalkyl orthosilicate | | Organic silane | | Solvent | | | |
| | | Content | | Content | | Content | | Content |
| Ex. No. | Type | (wt %) | Type | (wt %) | Type1 | (wt %) | Type2 | (wt %) |
| Ex. 1 | TEOS | 4.57 | — | — | H₂O | 51.48 | IPA | 41.49 |
| Ex. 2 | TEOS | 4.59 | — | — | H₂O | 89.23 | IPA | 4.17 |
| Ex. 3 | TEOS | 4.71 | — | — | H₂O | 11.98 | IPA | 81.96 |
| Ex. 4 | TEOS | 5.00 | — | — | H₂O | 13.20 | IPA | 79.80 |
| Ex. 5 | TEOS | 4.92 | — | — | H₂O | 13.07 | IPA | 79.02 |
| Ex. 6 | TEOS | 4.23 | — | — | H₂O | 54.63 | IPA | 38.44 |
| Ex. 7 | TEOS | 1.00 | — | — | H₂O | 6.63 | IPA | 91.68 |
| Ex. 8 | TEOS | 1.00 | — | — | H₂O | 3.58 | IPA | 94.53 |
| Ex. 9 | TEOS | 10.00 | — | — | H₂O | 21.48 | IPA | 66.03 |
| Ex. 10 | TEOS | 19.61 | — | — | H₂O | 39.00 | IPA | 36.79 |
| Ex. 11 | TEOS | 29.41 | — | — | H₂O | 55.17 | IPA | 8.85 |
| Ex. 12 | TMOS | 5.00 | — | — | H₂O | 13.23 | IPA | 80.28 |
| Ex. 13 | TEOS + TMOS⁽¹⁾ | 5.00 | — | — | H₂O | 13.23 | IPA | 80.28 |
| Ex. 14 | TEOS | 5.00 | — | — | H₂O | 13.23 | IPA | 80.28 |
| Ex. 15 | TEOS | 5.00 | — | — | H₂O | 22.73 | IPA | 70.78 |
| Ex. 16 | TEOS | 5.00 | — | — | H₂O | 21.73 | IPA | 70.78 |
| Ex. 17 | TEOS | 5.00 | — | — | H₂O | 22.73 | IPA | 70.78 |
| Ex. 18 | TEOS | 5.00 | — | — | H₂O | 22.73 | IPA | 70.78 |
| Ex. 19 | TEOS | 5.00 | — | — | H₂O | 22.73 | IPA | 70.78 |
| Ex. 20 | TEOS | 3.59 | — | — | H₂O | 61.57 | IPA | 32.30 |
| Ex. 21 | TEOS | 3.44 | — | — | H₂O | 62.78 | IPA | 30.92 |
| Ex. 22 | TEOS | 3.28 | — | — | H₂O | 64.02 | IPA | 29.51 |
| Ex. 23 | TEOS | 5.00 | — | — | H₂O | 13.23 | Ethanol | 80.28 |
| Ex. 24 | TEOS | 5.00 | — | — | H₂O | 13.23 | n-Butanol | 80.28 |
| Ex. 25 | TEOS | 5.00 | — | — | H₂O | 13.23 | n-Propanol | 80.28 |
| Ex. 26 | TEOS | 4.57 | Nalco 1050 | 0.05 | H₂O | 49.76 | IPA | 41.48 |
| Ex. 27 | TEOS | 5.00 | Nalco 2326 | 0.53 | H₂O | 15.86 | IPA | 77.11 |
| Ex. 28 | TEOS | 4.35 | Nalco 8699 | 1.02 | H₂O | 52.67 | IPA | 39.47 |
| Ex. 29 | TEOS | 3.99 | Nalco 2326 | 1.99 | H₂O | 53.87 | IPA | 36.22 |
| Ex. 30 | TEOS | 4.82 | Zwitterionic silane | 0.50 | H₂O | 60.89 | IPA | 31.19 |
| Ex. 31 | TEOS | 4.77 | Zwitterionic silane | 0.98 | H₂O | 60.79 | IPA | 30.89 |
| Ex. 32 | TEOS | 4.70 | Zwitterionic silane | 1.74 | H₂O | 60.62 | IPA | 30.41 |
| Ex. 33 | TEOS | 4.57 | Zwitterionic silane | 3.02 | H₂O | 60.34 | IPA | 29.60 |
| Ex. 34 | TEOS | 4.30 | ECC-1000 | 0.08 | H₂O | 18.67 | IPA | 74.81 |
| Ex. 35 | TEOS | 4.29 | ECC-1000 | 0.13 | H₂O | 18.66 | IPA | 74.78 |
| Ex. 36 | TEOS | 4.29 | ECC-1000 | 0.21 | H₂O | 18.65 | IPA | 74.72 |
| Ex. 37 | TEOS | 4.28 | ECC-1000 | 0.42 | H₂O | 18.61 | IPA | 74.56 |
| Ex. 38 | TEOS | 4.09 | ECC-1000 | 4.97 | H₂O | 17.76 | IPA | 71.15 |
| Ex. 39 | TEOS | 4.26 | HFPO-QUAT silane | 0.42 | H₂O | 18.53 | IPA | 74.67 |
| CEx. 1 | TEOS | 5.04 | — | — | H₂O | 47.52 | IPA | 45.76 |
| CEx. 2 | TEOS | 5.19 | — | — | H₂O | 3.87 | IPA | 90.43 |

| | | | Metal salt | | Surfactant | | Reaction |
|---|---|---|---|---|---|---|---|
| | Acid | | | Content | | Content | time |
| Ex. No. | Type | PH | Type | (wt %) | Type | (wt %) | (Hr) |
| Ex. 1 | H₃PO₄ | 1-2 | Al(NO₃)₃ | 0.91 | BG-10 | 0.20 | 168 |
| Ex. 2 | H₃PO₄ | 2-3 | Al(NO₃)₃ | 0.92 | BG-10 | 0.20 | 168 |
| Ex. 3 | HNO₃ | 3-4 | Al(NO₃)₃ | 0.94 | — | — | 168 |
| Ex. 4 | CH₃COOH | 1-2 | Al(NO₃)₃ | 1.00 | — | — | 168 |
| Ex. 5 | HCOOH | 2-3 | Al(NO₃)₃ | 0.98 | — | — | 168 |
| Ex. 6 | C₆H₈O₇•H₂O | 2-3 | Al(NO₃)₃ | 1.69 | BG-10 | 0.20 | 168 |
| Ex. 7 | HCl | 1-2 | Al(NO₃)₃ | 0.20 | — | — | 168 |
| Ex. 8 | HCl | 1-2 | Al(NO₃)₃ | 0.40 | — | — | 168 |
| Ex. 9 | HCl | 1-2 | Al(NO₃)₃ | 2.00 | — | — | 168 |
| Ex. 10 | HCl | 1-2 | Al(NO₃)₃ | 3.92 | BG-10 | 0.20 | 168 |
| Ex. 11 | HCl | 1-2 | Al(NO₃)₃ | 5.88 | BG-10 | 0.20 | 168 |
| Ex. 12 | HCl | 1-2 | Al(NO₃)₃ | 1.00 | — | — | 168 |
| Ex. 13 | HCl | 1-2 | Al(NO₃)₃ | 1.00 | — | — | 168 |
| Ex. 14 | HCl | 1-2 | Al(NO₃)₃ | 1.00 | — | — | 168 |
| Ex. 15 | HCl | 1-2 | Sr(N0₃)₂ | 1.00 | — | — | 168 |
| Ex. 16 | HCl | 1-2 | Cr(NO₃)₃ | 2.00 | — | — | 168 |
| Ex. 17 | HCl | 1-2 | Zr(N0₃)₄ | 1.00 | — | — | 168 |
| Ex. 18 | HCl | 1-2 | Ce(N0₃)₃ | 1.00 | — | — | 168 |
| Ex. 19 | HCl | 1-2 | Al(NO₃)₃ + Ce(NO₃)₃ ⁽²⁾ | 1.00 | — | — | 168 |
| Ex. 20 | H₃PO₄ | 1-2 | Al(NO₃)₃ | 1.50 | BG-10 | 0.05 | 72 |
| Ex. 21 | H₃PO₄ | 1-2 | Al(NO₃)₃ | 1.43 | BG-10 | 0.50 | 144 |
| Ex. 22 | H₃PO₄ | 1-2 | Al(NO₃)₃ | 1.37 | BG-10 | 1.00 | 192 |
| Ex. 23 | HCl | 1-2 | Al(NO₃)₃ | 1.00 | — | — | 168 |
| Ex. 24 | HCl | 1-2 | Al(NO₃)₃ | 1.00 | — | — | 168 |
| Ex. 25 | HCl | 1-2 | Al(NO₃)₃ | 1.00 | — | — | 168 |
| Ex. 26 | H₃PO₄ | 1-2 | Al(NO₃)₃ | 0.91 | C2M | 1.88 | 168 |
| Ex. 27 | HCl | 1-2 | Al(NO₃)₃ | 1.00 | — | — | 168 |
| Ex. 28 | H₃PO₄ | 1-2 | Al(NO₃)₃ | 0.87 | S-90 | 0.34 | 168 |
| Ex. 29 | H₃PO₄ | 1-2 | Al(NO₃)₃ | 0.80 | SDS | 0.50 | 168 |
| Ex. 30 | HCl | 1-2 | Al(NO₃)₃ | 1.45 | BG-10 | 0.20 | 168 |
| Ex. 31 | HCl | 1-2 | Al(NO₃)₃ | 1.43 | BG-10 | 0.20 | 168 |
| Ex. 32 | HCl | 1-2 | Al(NO₃)₃ | 1.41 | BG-10 | 0.20 | 168 |
| Ex. 33 | HCl | 1-2 | Al(NO₃)₃ | 1.37 | BG-10 | 0.20 | 168 |
| Ex. 34 | HCl | 1-2 | Al(NO₃)₃ | 1.72 | — | — | 24 |
| Ex. 35 | HCl | 1-2 | Al(NO₃)₃ | 1.72 | — | — | 24 |
| Ex. 36 | HCl | 1-2 | Al(NO₃)₃ | 1.72 | — | — | 24 |
| Ex. 37 | HCl | 1-2 | Al(NO₃)₃ | 1.71 | — | — | 24 |
| Ex. 38 | HCl | 1-2 | Al(NO₃)₃ | 1.63 | — | — | 24 |
| Ex. 39 | HCl | 1-2 | Al(NO₃)₃ | 1.71 | — | — | 72 |
| CEx. 1 | H₃PO₄ | 1-2 | — | — | BG-10 | 0.20 | 168 |
| CEx. 2 | HCl | 1-2 | — | — | — | — | 168 |

Note:
⁽¹⁾In Ex. 13, the weight ratio of TEOS to TMOS is 9:1;
⁽²⁾ In Ex. 19, the weight ratio of Al(NO₃)₃ to Ce(NO₃)₃ is 3:1.

### Preparation and Performance Test of Anti-Corrosion Article

### Example 40

The anti-corrosion article was made by the dip coating technique, comprising:

Using the stainless steel panel (5 cm×10 cm×1 mm) as the substrate of the anti-corrosion article, cleaning the surface of the stainless steel panel with ethyl acetate first, and then blowing it dry with compressed air;

Pouring 200 g of the anti-corrosion solution from Ex. 1 into a 400 ml stainless steel tank (15 cm×15 cm×2 cm);

Dip coating the stainless steel panel in the anti-corrosion solution by using an automatic dip coating machine (SKVDX2S-500, available from KSV NIMA) at room temperature;

The dipping-in speed of the dip coating process was 300 mm/min, the immersion time was 1 min, and the pull speed was 300 mm/min, the details of which are listed in Table 3;

After being heated in an oven at 150° C. for 15 min, the dip-coated stainless steel panel was removed from the oven and cooled to room temperature, producing an anti-corrosion article.

The salt spray resistance performance, the food stain resistance performance, the durability performance, the acid resistance performance, the high temperature and high humidity resistance performance, and the surface wettability performance of the obtained anti-corrosion article were measured, and the results of the tests are listed in Table 4, 5 and 6.

### Examples 41-79

The same procedure as in Ex. 40 was followed to produce the anti-corrosion article. The substrate type, dip coating conditions and heat treatment conditions of the anti-corrosion article are listed in Table 3.

The salt spray resistance performance, the food stain resistance performance, the durability performance, the acid resistance performance, the high temperature and high humidity resistance performance, and the surface wettability performance of the obtained anti-corrosion articles were measured, and the results of the tests are listed in Table 4, 5 and 6.

### Example 80

The anti-corrosion article was made by the dip coating technique, comprising:

Using the stainless steel panel (5 cm×10 cm×1 mm) as the substrate of the anti-corrosion article, cleaning the surface of the stainless steel panel with ethyl acetate first, and then blowing it dry with compressed air;

Filtering 200 g of the anti-corrosion solution from Ex. 34 twice with a 200 mesh filter screen;

Pouring the anti-corrosion solution filtered out into a 400 ml stainless steel tank (15 cm×15 cm×2 cm);

Dip coating the stainless steel panel by using an automatic dip coating machine (SKVDX2S-500, available from KSV NIMA) at room temperature;

The dipping-in speed of the dip coating process is 300 mm/min, the immersion time is 1 min, and the pull speed is 300 mm/min, the details of which are listed in Table 3;

After being heated in an oven at 150° C. for 10 min, the dip-coated stainless steel panel was removed from the oven and cooled to room temperature, producing an anti-corrosion article.

The salt spray resistance performance, the food stain resistance performance, the durability performance, the acid resistance performance, the high temperature and high humidity resistance performance, and the surface wettability performance of the obtained anti-corrosion article were measured, and the results of the tests are listed in Table 4, 5 and 6.

### Examples 81-86

The same procedure as in Ex. 80 was followed to prepare anti-corrosion articles. The substrate type, the dip coating conditions and heat treatment conditions of the anti-corrosion articles are listed in Table 3.

The salt spray resistance performance, the food stain resistance performance, the durability performance, the acid resistance performance, the high temperature and high humidity resistance performance, and the surface wettability performance of the obtained anti-corrosion article were measured, and the results of the tests are listed in Table 4, 5 and 6.

### Example 87

The anti-corrosion article was made by the spray coating technique, comprising:

Using the stainless steel panel (5 cm×10 cm×1 mm) as the substrate of the anti-corrosion article, and cleaning the stainless steel panel with ethyl acetate first, and then blowing it dry with compressed air;

Filtering 20 g of anti-corrosion solution from Ex. 37 twice with a 200 mesh filter screen;

Pouring the anti-corrosion solution filtered out into a storage tank for spray gun solution;

Spraying the anti-corrosion solution to the surface of the stainless steel panel with a spray gun at room temperature;

In the spray coating process, the diameter of the spray gun nozzle was 1.0-1.5 mm, the spray coating pressure was 0.2 MPa, the distance from the nozzle to the stainless steel panel was 15-35 cm, and the spray coating times were 1-3 times, the details of which are listed in Table 3;

After being heated in an oven at 150° C. for 10 min, the spray coated stainless steel panel was removed from the oven and cooled to room temperature, producing an anti-corrosion article.

The salt spray resistance performance, the food stain resistance performance, the durability performance, the acid resistance performance, the high temperature and high humidity resistance performance, and the surface wettability performance of the obtained anti-corrosion article were measured, and the results of the tests are listed in Table 4, 5 and 6.

### Examples 88-90

The same procedure as in Ex. 87 was followed to prepare the anti-corrosion articles. The substrate type, the coating conditions and the heat treatment conditions of the anti-corrosion article are listed in Table 3.

The salt spray resistance performance, the food stain resistance performance, the durability performance, the acid resistance performance, the high temperature and high humidity resistance performance, and the surface wettability performance of the obtained anti-corrosion article were measured, and the results of the tests are listed in Table 4, 5 and 6.

### Comparative Examples 3-4

The same procedure as in Ex. 40 was followed to prepare the anti-corrosion articles. The anti-corrosion solution was from CEx. 1-2, the details of which are listed in Table 3.

The salt spray resistance performance, the food stain resistance performance, the durability performance, the acid resistance performance, the high temperature and high humidity resistance performance, and the surface wettability performance of the obtained anti-corrosion articles were measured, and the results of the tests are listed in Table 4, 5 and 6.

TABLE 3
Preparation of anti-corrosion articles

| | | | Coating technique | | | | |
|---|---|---|---|---|---|---|---|
| | | | Dip coating | | Spray coating | | |
| Preparation | | | Dipping-in | | Spray | Spary | |
| of anti- | Anti- | | & Pull | Immersion | coating | coating | Heat |
| corrosion | corrosion | | speed | time | distance | times | treatment |
| article | solution | Substrate | (mm/min) | (min) | (cm) | (times) | condition |
| Ex. 40 | Ex. 1 | 443 Stainless steel | 300 | 1 | — | — | 150° C./15 min |
| Ex. 41 | Ex. 1 | 439 Stainless steel | 300 | 1 | — | — | 150° C./20 min |
| Ex. 42 | Ex. 2 | 443 Stainless steel | 300 | 1 | — | — | 150° C./10 min |
| Ex. 43 | Ex. 3 | 439 Stainless steel | 300 | 1 | — | — | 150° C./10 min |
| Ex. 44 | Ex. 4 | 443 Stainless steel | 300 | 1 | — | — | 150° C./10 min |
| Ex. 45 | Ex. 5 | 443 Stainless steel | 300 | 1 | — | — | 150° C./10 min |
| Ex. 46 | Ex. 6 | 443 Stainless steel | 300 | 1 | — | — | 150° C./10 min |
| Ex. 47 | Ex. 7 | 443 Stainless steel | 300 | 1 | — | — | 150° C./10 min |
| Ex. 48 | Ex. 8 | 443 Stainless steel | 600 | 1 | — | — | 150° C./10 min |
| Ex. 49 | Ex. 9 | 443 Stainless steel | 300 | 1 | — | — | 150° C./10 min |
| Ex. 50 | Ex. 10 | 443 Stainless steel | 30 | 1 | — | — | 150° C./10 min |
| Ex. 51 | Ex. 11 | 443 Stainless steel | 30 | 1 | — | — | 150° C./10 min |
| Ex. 52 | Ex. 12 | 443 Stainless steel | 300 | 1 | — | — | 150° C./10 min |
| Ex. 53 | Ex. 13 | 443 Stainless steel | 300 | 1 | — | — | 150° C./10 min |
| Ex. 54 | Ex. 14 | Aluminum | 300 | 1 | — | — | 150° C./10 min |
| Ex. 55 | Ex. 14 | Glass | 300 | 1 | — | — | 150° C./10 min |
| Ex. 56 | Ex. 14 | Painted plate | 300 | 1 | — | — | 150° C./10 min |
| Ex. 57 | Ex. 14 | Ceramic | 300 | 1 | — | — | 150° C./10 min |
| Ex. 58 | Ex. 15 | 443 Stainless steel | 300 | 1 | — | — | 150° C./10 min |
| Ex. 59 | Ex. 16 | 443 Stainless steel | 300 | 1 | — | — | 150° C./10 min |
| Ex. 60 | Ex. 17 | 443 Stainless steel | 300 | 1 | — | — | 150° C./10 min |
| Ex. 61 | Ex. 18 | 443 Stainless steel | 300 | 1 | — | — | 150° C./10 min |
| Ex. 62 | Ex. 19 | 443 Stainless steel | 300 | 1 | — | — | 150° C./10 min |
| Ex. 63 | Ex. 20 | 443 Stainless steel | 300 | 1 | — | — | 150° C./10 min |
| Ex. 64 | Ex. 20 | 430 Stainless steel | 300 | 1 | — | — | 150° C./10 min |
| Ex. 65 | Ex. 21 | 443 Stainless steel | 300 | 1 | — | — | 150° C./10 min |
| Ex. 66 | Ex. 21 | 430 Stainless steel | 300 | 1 | — | — | 150° C./10 min |
| Ex. 67 | Ex. 22 | 443 Stainless steel | 300 | 1 | — | — | 150° C./10 min |
| Ex. 68 | Ex. 22 | 430 Stainless steel | 300 | 1 | — | — | 150° C./10 min |
| Ex. 69 | Ex. 23 | 443 Stainless steel | 300 | 1 | — | — | 150° C./10 min |
| Ex. 70 | Ex. 24 | 443 Stainless steel | 300 | 1 | — | — | 150° C./10 min |
| Ex. 71 | Ex. 25 | 443 Stainless steel | 300 | 1 | — | — | 150° C./10 min |
| Ex. 72 | Ex. 26 | 443 Stainless steel | 300 | 1 | — | — | 150° C./10 min |
| Ex. 73 | Ex. 27 | 443 Stainless steel | 300 | 1 | — | — | 150° C./10 min |
| Ex. 74 | Ex. 28 | 443 Stainless steel | 300 | 1 | — | — | 150° C./10 min |
| Ex. 75 | Ex. 29 | 443 Stainless steel | 300 | 1 | — | — | 150° C./10 min |
| Ex. 76 | Ex. 30 | 443 Stainless steel | 300 | 1 | — | — | 150° C./10 min |
| Ex. 77 | Ex. 31 | 443 Stainless steel | 300 | 1 | — | — | 150° C./10 min |
| Ex. 78 | Ex. 32 | 443 Stainless steel | 300 | 1 | — | — | 150° C./10 min |
| Ex. 79 | Ex. 33 | 443 Stainless steel | 300 | 1 | — | — | 150° C./10 min |
| Ex. 80 | Ex. 34 | 304 Stainless steel | 300 | 1 | — | — | 150° C./10 min |
| Ex. 81 | Ex. 35 | 304 Stainless steel | 300 | 1 | — | — | 150° C./10 min |
| Ex. 82 | Ex. 36 | 304 Stainless steel | 300 | 1 | — | — | 150° C./10 min |
| Ex. 83 | Ex. 37 | 304 Stainless steel | 300 | 1 | — | — | 150° C./10 min |
| Ex. 84 | Ex. 38 | Glass | 150 | 1 | — | — | 150° C./10 min |
| Ex. 85 | Ex. 38 | 304 Stainless steel | 300 | 1 | — | — | 150° C./10 min |
| Ex. 86 | Ex. 39 | 304 Stainless steel | 300 | 1 | — | — | 160° C./15 min |
| Ex. 87 | Ex. 37 | 304 Stainless steel | — | — | 15 | 1 | 150° C./10 min |
| Ex. 88 | Ex. 37 | 304 Stainless steel | — | — | 25 | 2 | 150° C./10 min |
| Ex. 89 | Ex. 37 | 304 Stainless steel | — | — | 35 | 3 | 40° C./3 h |
| Ex. 90 | Ex. 39 | 304 Stainless steel | — | — | 20 | 3 | 160° C./15 min |
| CEx. 3 | CEx. 1 | 439 Stainless steel | 300 | 1 | — | — | 150° C./10 min |
| CEx. 4 | CEx. 2 | 439 Stainless steel | 300 | 1 | — | — | 150° C./10 min |

TABLE 4
Salt spray resistance performance test of anti-corrosion articles

| Anti-corrosion article | Salt spray resistance performance (Hr) |
|---|---|
| Ex. 40 | 1000 |
| Ex. 41 | 1000 |
| Ex. 42 | 250 |
| Ex. 43 | 500 |
| Ex. 44 | 1000 |
| Ex. 45 | 1000 |
| Ex. 46 | 250 |
| Ex. 47 | 500 |
| Ex. 48 | 750 |
| Ex. 49 | 1000 |
| Ex. 50 | 1000 |
| Ex. 51 | 1000 |
| Ex. 52 | 1000 |
| Ex. 53 | 1000 |
| Ex. 54 | 1000 |
| Ex. 55 | 1000 |
| Ex. 56 | 1000 |
| Ex. 57 | 1000 |
| Ex. 58 | 250 |
| Ex. 59 | 250 |
| Ex. 60 | 500 |
| Ex. 61 | 500 |
| Ex. 62 | 1000 |
| Ex. 63 | 1000 |
| Ex. 64 | 1000 |
| Ex. 65 | 1000 |
| Ex. 66 | 500 |
| Ex. 67 | 1000 |
| Ex. 68 | 1000 |
| Ex. 69 | 1000 |
| Ex. 70 | 1000 |
| Ex. 71 | 1000 |
| Ex. 72 | 1000 |
| Ex. 73 | 1000 |
| Ex. 74 | 500 |
| Ex. 75 | 850 |
| Ex. 76 | 1000 |
| Ex. 77 | 1000 |
| Ex. 78 | 1000 |
| Ex. 79 | 1000 |
| Ex. 80 | 1000 |
| Ex. 81 | 1000 |
| Ex. 82 | 1000 |
| Ex. 83 | 1000 |
| Ex. 84 | 1000 |
| Ex. 85 | 1000 |
| Ex. 86 | 1000 |
| Ex. 87 | 1000 |
| Ex. 88 | 1000 |
| Ex. 89 | 1000 |
| Ex. 90 | 1000 |
| CEx. 3 | 120 |
| CEx. 4 | 100 |

It can be seen from Table 4 that the salt spray resistance time of the anti-corrosion articles of Ex. 40-90 all reach as high as at least 250 hrs, indicating that these anti-corrosion articles have good salt spray resistance performance However, the salt spray resistance time of the anti-corrosion articles of CEx 3-4 reach a maximum of 120 hrs, indicating poor salt spray resistance performance

TABLE 5
Food stain resistance performance test of anti-corrosion articles

| | Soy sauce | Chilli sauce | Ketchup |
|---|---|---|---|
| Anti-corrosion | resistance | resistance | resistance |
| article | performance test | performance test | performance test |
| Ex. 40 | pass | pass | pass |
| Ex. 41 | pass | pass | pass |
| Ex. 42 | pass | pass | fail |
| Ex. 43 | pass | fail | pass |
| Ex. 44 | pass | fail | pass |
| Ex. 45 | pass | pass | pass |
| Ex. 49 | pass | pass | pass |
| Ex. 50 | pass | pass | pass |
| Ex. 51 | pass | pass | pass |
| Ex. 52 | pass | pass | pass |
| Ex. 53 | pass | pass | pass |
| Ex. 58 | pass | pass | fail |
| Ex. 59 | pass | pass | pass |
| Ex. 60 | pass | pass | pass |
| Ex. 61 | pass | pass | pass |
| Ex. 62 | pass | pass | pass |
| Ex. 63 | pass | pass | pass |
| Ex. 65 | pass | fail | pass |
| Ex. 66 | pass | fail | pass |
| Ex. 67 | pass | pass | pass |
| Ex. 68 | pass | pass | pass |
| Ex. 69 | pass | pass | fail |
| Ex. 70 | pass | pass | pass |
| Ex. 71 | pass | pass | pass |
| Ex. 72 | pass | pass | pass |
| Ex. 73 | pass | pass | pass |
| Ex. 74 | pass | pass | fail |
| Ex. 75 | pass | pass | pass |
| Ex. 80 | pass | pass | pass |
| Ex. 81 | pass | pass | pass |
| Ex. 82 | pass | pass | pass |
| Ex. 83 | pass | pass | pass |
| Ex. 84 | pass | pass | pass |
| Ex. 85 | pass | pass | pass |
| Ex. 86 | pass | pass | pass |
| Ex. 87 | pass | pass | pass |
| Ex. 88 | pass | pass | pass |
| Ex. 89 | pass | pass | pass |
| Ex. 90 | pass | pass | pass |
| CEx. 3 | fail | fail | fail |
| CEx. 4 | pass | fail | fail |

It can be seen from Table 5 that the anti-corrosion articles according to some preferred examples of the present invention can further pass at least two food stain resistance performance tests, therefore the anti-corrosion articles provided by these preferred examples also have good food stain resistance performance. The anti-corrosion articles provided by CEx.3-4 passed only one food stain resistance performance test, indicating poor food stain resistance performance.

TABLE 6
Durability performance, acid resistance performance, high
temperature and high humidity resistance performance, and
surface wettability performance test of the anti-corrosion articles

| | | | High | |
|---|---|---|---|---|
| | | | temperature | |
| | | | and high | Contact |
| | Cycles of | Acid | humidity | angle in surface |
| Anti- | Durability | resistance | resistance | wettability |
| corrosion | performance | performance | performance | performance test |
| article | test | test | test | (CA°) |
| Ex. 40 | 20000 | pass | pass | 30.5 |
| Ex. 41 | 20000 | pass | fail | 31.6 |
| Ex. 65 | Not tested | pass | pass | Not tested |
| Ex. 66 | Not tested | pass | pass | Not tested |
| Ex. 67 | Not tested | pass | pass | Not tested |
| Ex. 68 | Not tested | pass | pass | Not tested |
| Ex. 73 | Not tested | pass | pass | 53.8 |
| Ex. 83 | 20000 | pass | pass | 115.9 |
| Ex. 84 | 20000 | Not tested | Not tested | 117.3 |
| Ex. 85 | 20000 | pass | pass | 121.1 |
| Ex. 87 | 20000 | pass | pass | 113.6 |
| Ex. 88 | 20000 | pass | pass | 114.1 |
| Ex. 89 | Not tested | pass | pass | 115.5 |
| Ex. 90 | 20000 | Not tested | Not tested | 102.6 |
| CEx. 3 | 20000 | fail | fail | 20.6 |
| CEx. 4 | 20000 | fail | fail | 56.4 |

Note:
contact angle of water on a blank stainless steel panel is about 80°.

Note: contact angle of water on a blank stainless steel panel is about 80°.

It can be seen from Table 6 that the anti-corrosion articles according to some preferred examples of the present invention can further pass at least one of the following tests: durability performance test, acid resistance performance test and high temperature and high humidity resistance performance test. Therefore, the anti-corrosion articles provided by these preferred examples also have good durability performance, acid resistance performance, and high temperature and high humidity resistance performance. In addition, according to some preferred examples of the present invention, a proper amount of surfactant or organic silane can be added to the anti-corrosion solution to adjust the surface wettability of the anti-corrosion article.

For illustration purposes, the above specific embodiments comprise many details, but it shall be understood by those skilled in the art that many variations, changes, substitutions and modifications all fall into the scope of the claims of the present invention. Therefore, the disclosure described in the specific embodiments shall not be construed as limiting the present invention protected by the claims. The proper scope of the invention shall be defined by the claims and proper legal equivalents. All cited documents are incorporated herein for reference in their entirety.

1. An anti-corrosion solution, comprising a reaction product of the following reaction components:
from 1 to 10 wt % of a tetraalkyl orthosilicate, with the total weight of the anti-corrosion solution being 100 wt %;
from 0.2 to 6.0 wt % of a metal salt, with the total weight of the anti-corrosion solution being 100 wt %, the metal salt comprising one or more selected from the group consisting of an aluminum salt, a strontium salt, a chromium salt, a zirconium salt, and a cerium salt;
an acid;
from 3 to 90 wt % of water, with the total weight of the anti-corrosion solution being 100 wt %; and
from 4 to 95 wt % of an alcohol, with the total weight of the anti-corrosion solution being 100 wt %;
the anti-corrosion solution having a pH value less than or equal to 4.

2. The anti-corrosion solution according to claim 1, wherein:
the tetraalkyl orthosilicate is represented by the general formula Si(OR)₄, wherein R represents an alkyl group having from 1 to 4 carbons, the alkyl group comprising one or more selected from the group consisting of methyl, ethyl, n-propyl, isopropyl, and n-butyl groups.

3. The anti-corrosion solution according to claim 1, wherein a content of the tetraalkyl orthosilicate is from 5 to 10 wt %.

4. The anti-corrosion solution according to claim 1, wherein the metal salt comprises one or more selected from the group consisting of aluminum nitrate, strontium nitrate, chromium nitrate, zirconium nitrate and cerium nitrate.

5. The anti-corrosion solution according to claim 1, wherein a content of the metal salt is from 0.5 to 4.0 wt %.

6. The anti-corrosion solution according to claim 1, wherein:
the acid is an inorganic acid or an organic acid;
the inorganic acid comprising one or more selected from the group consisting of hydrochloric acid, nitric acid, and phosphoric acid; and
the organic acid comprising one or more selected from the group consisting of formic acid, acetic acid, and citric acid.

7. The anti-corrosion solution according to claim 1, wherein the alcohol comprises one or more selected from the group consisting of ethanol, n-propanol, isopropanol, and n-butanol.

8. The anti-corrosion solution according to claim 1, wherein a content of water is from 3.58 to 89.23 wt %, and a content of the alcohol is from 4.17 to 94.53 wt %.

9. The anti-corrosion solution according to claim 1, wherein the anti-corrosion solution further comprises from 0.05 to 2.0 wt % of nanosilica particles, with the total weight of the anti-corrosion solution being 100 wt %.

10. The anti-corrosion solution according to claim 9, wherein the nanosilica particles have an average particle diameter of 2 to 20 nm.

11. The anti-corrosion solution according to claim 1, wherein the anti-corrosion solution further comprises an organic silane.

12. The anti-corrosion solution according to claim 11, wherein:
the organic silane is perfluoropolyether silane, a content of the perfluoropolyether silane being from 0.08 to 5.0 wt %, with the total weight of the anti-corrosion solution being 100 wt %.

13. The anti-corrosion solution according to claim 11, wherein:
the organic silane is a quaternary ammonium salt zwitterionic silane, the quaternary ammonium salt zwitterionic silane being in an amount of 0.5-3.1 wt %, with the total weight of the anti-corrosion solution being 100 wt %.

14. The anti-corrosion solution according to claim 1, wherein the anti-corrosion solution further comprises from 0.05 to 2.0 wt % of a surfactant, with the total weight of the anti-corrosion solution being 100 wt %.

15. The anti-corrosion solution according to claim 14, wherein the surfactant comprises one or more selected from the group consisting of a nonionic surfactant, an anionic surfactant, and an amphoteric surfactant.

16. The anti-corrosion solution according to claim 15, wherein the nonionic surfactant comprises one or more selected from the group consisting of a polyoxyethylene-type nonionic surfactant, a polyol-type nonionic surfactant, an alkanolamide-type nonionic surfactant, a fluorocarbon-type nonionic surfactant, a silicone-type nonionic surfactant, and a modified silicone-type nonionic surfactant.

17. The anti-corrosion solution according to claim 15, wherein the anionic surfactant comprises one or more selected from the group consisting of a carboxylate-type anionic surfactant, a sulphonate-type anionic surfactant, a sulphate-type anionic surfactant, and a phosphate-type anionic surfactant.

18. The anti-corrosion solution according to claim 15, wherein the amphoteric surfactant comprises one or more selected from the group consisting of an amino acid-type amphoteric surfactant, a betaine-type amphoteric surfactant, and an imidazoline-type amphoteric surfactant.

19. An anti-corrosion article comprising a substrate and an anti-corrosion coating layer positioned adjacent to the substrate, wherein the anti-corrosion layer comprises a layer of the anti-corrosion solution according to claim 1 that has been dried to remove the solvent.

20. The anti-corrosion article according to claim 19, wherein the substrate comprises one or more selected from the group consisting of a stainless steel substrate, a glass substrate, an aluminum substrate, an aluminum alloy substrate, a ceramic substrate, and a painted substrate.

21. A method of forming an anti-corrosion article, the method comprising:
applying the anti-corrosion solution according to claim 1 to a substrate to form a layer of the anti-corrosion solution positioned adjacent to the substrate; and
drying the layer of the anti-corrosion solution to remove the solvent and form an anti-corrosion coating layer.

22. The method according to claim 21, wherein applying comprises one or more selected from the group consisting of dip coating application, spray coating application, roll coating application, and brush coating application.

23. The method according to claim 21, wherein the substrate comprises one or more selected from the group consisting of a stainless steel substrate, a glass substrate, an aluminum substrate, an aluminum alloy substrate, a ceramic substrate, and a painted substrate.
